(19) United States
(12) Patent Application Publication
(10) Pub. No.: US 2024/0246520 A1
(43) Pub. Date: Jul. 25, 2024

(54) METHOD FOR OPERATING AN ELECTROPNEUMATIC BRAKE SYSTEM, FAIL-SAFETY VALVE UNIT, ELECTROPNEUMATIC BRAKE SYSTEM AND VEHICLE

(71) Applicant: ZF CV Systems Global GmbH, Bern (CH)

(72) Inventor: Julian van Thiel, Grossburgwedel (DE)

(21) Appl. No.: 18/444,052

(22) Filed: Feb. 16, 2024

Related U.S. Application Data
(63) Continuation of application No. PCT/EP2022/073010, filed on Aug. 17, 2022.

(30) Foreign Application Priority Data
Aug. 31, 2021 (DE) 10 2021 122 497.7

(51) Int. Cl. B60T 13/38; B60T 8/171; B60T 8/172; B60T 13/26; B60T 13/68

(52) U.S. Cl. CPC B60T 13/385; B60T 8/171; B60T 8/172; B60T 13/268; B60T 13/683; B60T 2270/402; B60T 2270/413

(57) ABSTRACT

A method is for operating a vehicle's electropneumatic brake system. The brake system includes a service brake system and a parking brake system. The parking brake system includes a spring brake cylinder. A control signal for maintaining a spring brake pressurization pressure, which pressurizes the spring brake cylinder, is provided via a control unit. The provision of the control signal is suspended in at least one of a fault event and/or in the event of an electrical failure and/or in a diagnostic event of the control unit and thus automatically ending the maintenance of the spring brake pressurization pressure to ventilate the spring brake cylinder and thus initiating a spring brake failsafe braking operation of the vehicle via the parking brake system. The ventilation of the spring brake pressurization pressure is performed by a service brake ventilation function of the service brake system.

### CROSS-REFERENCE TO RELATED APPLICATIONS

This application is a continuation application of international patent application PCT/EP2022/073010, filed Aug. 17, 2022, designating the United States and claiming priority from German application 10 2021 122 497.7, filed Aug. 31, 2021, and the entire content of both applications is incorporated herein by reference.

### TECHNICAL FIELD

The disclosure relates to a method for operating an electropneumatic brake system for a vehicle. The disclosure furthermore relates to a fail-safety valve unit and to an electropneumatic brake system that is configured to carry out a method of the aforementioned type. The disclosure furthermore relates to a vehicle that is configured to carry out a method of the aforementioned type and/or having a fail-safety valve unit of the aforementioned type and/or having an electropneumatic brake system of the aforementioned type.

### BACKGROUND

Safety concepts are highly relevant in electropneumatic brake systems for modern vehicles. In particular in vehicles with automated or partially automated driving functions, concepts for initiating a failsafe braking operation in a fault event or in the event of an electrical failure of a control unit contribute significantly to the safety of the vehicle, of its occupants and of other road users. Such concepts allow the vehicle to be safely stopped in a fault event or in the event of an electrical failure.

In principle, there are concepts that implement a failsafe braking operation via a service braking system and concepts that implement this via a parking brake system. Here, brake systems often use both concepts to implement two or more fall-back levels, which are then based on the different concepts. In the case of concepts based on a parking brake system, there is the advantage, in principle, that safe stoppage of the vehicle is possible by ventilating a preloaded spring brake cylinder, without the need to pressurize a brake actuator with compressed air.

For example, DE 10 2019 131 930 A1 has already described an electropneumatic parking brake module for an electronically controllable pneumatic brake system for a vehicle, having a reservoir port for receiving a reservoir pressure, at least one parking brake port for the connection of at least one parking brake cylinder, a main valve unit which receives the reservoir pressure and which is configured to output a spring brake pressure at the parking brake port in a manner dependent on a control pressure, and a pilot-control valve arrangement which receives the reservoir pressure and which serves for providing the control pressure, wherein the pilot-control valve arrangement has a bistable valve, which is switchable between a first, pressurization position and a second, ventilation position, and a control unit for providing first and second switching signals to the pilot-control valve arrangement.

In the case of the electropneumatic parking brake module presented in DE 10 2019 131 930 A1, the pilot-control valve arrangement has a monostable pressure-maintaining valve which is connected pneumatically in series with the bistable valve and which is arranged in a control line of the main valve unit, wherein the pressure-maintaining valve is open, in an open position, when electrically deenergized, and the control unit is configured to hold the pressure-maintaining valve in the pressure-maintaining position via the first switching signal for the purposes of maintaining the control pressure, and a selector valve unit is arranged in the control line between the pressure-maintaining valve and a control port of the main valve unit, the selector valve unit having a first selector valve port for receiving an auxiliary control pressure that is provided at an auxiliary brake pressure port, wherein the selector valve unit has, at the first selector valve port, a non-return characteristic which is such that the first selector valve port opens in a flow direction from the auxiliary brake pressure port via a third selector valve port to the control port, and blocks counter to the flow direction.

Despite this approach, which is already advantageous in principle, concepts for providing a failsafe braking function still have potential for improvement. This relates in particular to the reliable provision of a failsafe braking function with little expenditure on apparatus, particularly advantageously using existing structures of the brake system.

It is therefore desirable to improve the function and/or the operation of an electropneumatic brake system.

### SUMMARY

It is an object of the disclosure to specify an improved method for operating an electropneumatic brake system having a fail-safety valve unit for a failsafe braking function. In particular, it is sought to be able to provide a failsafe braking function reliably and with little expenditure on apparatus.

The disclosure proceeds from a method for operating an electropneumatic brake system for a vehicle, preferably a utility vehicle, wherein the brake system includes a service brake system and a parking brake system, and the parking brake system includes at least one spring brake cylinder.

According to the disclosure, in the method, the following steps are provided: providing a control signal for maintaining a spring brake pressurization pressure, which pressurizes the at least one spring brake cylinder, via a control unit, suspending the provision of the control signal in a fault event and/or in the event of an electrical failure and/or in a diagnostic event of the control unit and thus automatically ending the maintenance of the spring brake pressurization pressure in order to ventilate the at least one spring brake cylinder and thus initiating a spring brake failsafe braking operation of the vehicle via the parking brake system, wherein the ventilation of the spring brake pressurization pressure is performed by a service brake ventilation function of the service brake system.

The disclosure is based on the consideration that, via a parking brake system, specifically by ventilation of at least one spring brake cylinder, a spring brake failsafe braking operation can be reliably initiated and in particular automatically maintained, in each case advantageously without further application of pressure.

Since the suspension of the provision of the control signal causes the maintenance of the spring brake pressurization pressure to be automatically ended, the at least one spring brake cylinder is ventilated. The ventilation causes the at least one spring brake cylinder to engage, that is, the at least one spring brake cylinder is transferred, by a pressure spring that was previously preloaded by the spring brake pressurization pressure, into a state in which a wheel brake assigned to the spring brake cylinder is actuated in order to brake the vehicle.

By virtue of the fact that the ventilation of the spring brake pressurization pressure or of the at least one spring brake cylinder is performed by a service brake ventilation function of the service brake system, the expenditure on apparatus for providing the failsafe braking function in the form of the spring brake failsafe braking operation can advantageously be kept low.

Provision can preferably be made for the initiation of the spring brake failsafe braking operation to occur within a reaction period after the suspension of the provision of the control signal. The reaction period can preferably be 30 seconds or less, particularly preferably 5 seconds or less. Such initiation of the spring brake failsafe braking operation within the reaction period is to be considered in particular in contrast to any systems in which ventilation of a spring brake cylinder takes place over a relatively long period for the purposes of securing a vehicle which is already at a standstill, for example for the purposes of compensating for leaks in the service brake system.

It is preferable for at least two spring brake cylinders of an axle, particularly preferably of a rear axle, to be ventilated in order to initiate a spring brake failsafe braking operation by way of the service brake ventilation function. The method is preferably configured for an electropneumatic brake system having a fail-safety valve unit for a failsafe braking function of the electropneumatic brake system.

In an embodiment, provision is made for the spring brake pressurization pressure to additionally act, during the ventilation by the service brake ventilation function, as a service brake failsafe brake pressure for initiating a service brake failsafe braking operation. In such an embodiment, the spring brake pressurization pressure can advantageously be used for ventilating the at least one spring brake cylinder in order to initiate a further failsafe braking function in the form of a service brake failsafe braking operation.

In an embodiment, provision is advantageously made for the service brake failsafe brake pressure to be provided via the failsafe brake port to at least one service brake cylinder and/or a service brake chamber and/or an axle modulator and/or a further pneumatic brake component. In the case of an axle modulator, the service brake failsafe brake pressure is preferably input to a pilot-control circuit in order to actuate a pneumatic main valve.

Provision is preferably made whereby, after the provision of the service brake failsafe brake pressure, the service brake failsafe brake pressure is confined, preferably in the at least one service brake cylinder and/or the service brake chamber and/or the axle modulator and/or the further pneumatic brake component. By virtue of the service brake failsafe brake pressure being confined, the service brake failsafe braking operation can be maintained long-term, even if the spring brake pressurization pressure has fallen below a failsafe brake pressure threshold value, in particular if the at least one spring brake cylinder has been emptied. In the case of an axle modulator, the service brake failsafe brake pressure is preferably confined in a pilot-control circuit.

The service brake ventilation function makes it possible for there to be at least one ventilation path, which is open continuously or in an interrupted manner over time, in the service brake system for the purposes of ventilating the at least one spring brake cylinder. The service brake ventilation function is implemented in particular by a valve in the service brake system, preferably an outlet valve and/or a further outlet valve. In embodiments, as an alternative or in addition to the ventilation path, a further ventilation path leads via at least one ABS valve and/or via a throttle, particularly preferably via a throttle that pneumatically connects a control line of an axle modulator to a working line of the axle modulator.

The disclosure is refined such that the service brake ventilation function includes the opening of an outlet valve of the service brake system.

The outlet valve is preferably arranged in a pilot-control circuit, which carries a service brake pilot-control pressure, of the service brake system, and the outlet valve is particularly preferably a pilot-control ventilation valve of an axle modulator. Such an outlet valve arranged in the pilot-control circuit of the service brake system is preferably an existing valve that particularly preferably serves some other primary purpose. An example for this is the pilot-control ventilation valve, which serves for ventilating the control port of a pneumatic valve, in particular relay valve, of the axle modulator. Provision is particularly preferably made for the service brake failsafe brake pressure to act as a service brake pilot-control pressure. In particular, this encompasses a situation where the spring brake ventilation pressure, which is provided at the failsafe brake port during the ventilation of the at least one spring brake cylinder, is used for pressurizing the pilot-control circuit of the service brake system. In other embodiments, the outlet valve may be arranged in a further pilot-control circuit, which carries a service brake pilot-control pressure, of the service brake system, for example in a pilot-control circuit of an ABS valve configured as a pneumatic valve.

The disclosure is refined such that the service brake ventilation function includes the opening of a further outlet valve. The further outlet valve is preferably arranged in a main circuit, which carries a service brake pressure, of the service brake system. The further outlet valve is particularly preferably a main valve of an axle modulator or an ABS valve. A main valve of the axle modulator is preferably a pneumatic valve that boosts an air flow rate, particularly preferably a relay valve. Such a further outlet valve that is arranged in a main circuit that carries a service brake pressure has the advantage of having a relatively large nominal size, leading to relatively quick ventilation of the at least one spring brake cylinder. In this way, it is possible to achieve an advantageously short reaction time prior to the initiation of the spring brake failsafe braking operation. Provision is particularly preferably made for the service brake failsafe brake pressure to act as a service brake pressure. In particular, this encompasses a situation where the spring brake ventilation pressure, which is provided at the failsafe brake port during the ventilation of the at least one spring brake cylinder, is used for pressurizing the main circuit of the service brake system.

In an embodiment, provision is made for the opening of the further outlet valve to be performed in continuous or pulsed fashion. Pulsed opening may particularly advantageously be implemented if the further outlet valve is an ABS valve. An ABS valve is generally configured to switch, in particular to ventilate, relatively large nominal sizes within short periods of time. The ABS valve is preferably configured as a directly switching solenoid valve. Nevertheless, in embodiments, the ABS valve may be configured as a pneumatically switched valve, in particular as a relay valve. The further outlet valve configured as an ABS valve may advantageously be opened in a manner that is known for an ABS valve for the purposes of preventing locking of an axle.

In various embodiments, the further outlet valve has a nominal size in a range from 5 mm to 15 mm, preferably in a range from 8 mm to 12 mm, particular preferably of 10 mm. In embodiments, the further outlet valve is an additional valve, in particular solenoid valve, which is preferably only used for implementing the service brake ventilation function. In general, the larger the nominal size, the quicker the ventilation of the at least one spring brake cylinder.

The outlet valve and/or the further outlet valve are/is advantageously permanently switched into a ventilating, preferably opened, position, or are/is switchable into the ventilating position upon the initiation of the service brake failsafe braking operation.

The outlet valve or the further outlet valve is preferably an existing valve of the service brake system, preferably with some other primary function. The outlet valve or the further outlet valve is advantageously configured to conduct the spring brake pressurization pressure into the surroundings for the purposes of ventilating the at least one spring brake cylinder. This may be performed directly, for example via a ventilation valve, or indirectly, for example after the spring brake pressurization pressure has been used for some other purpose beforehand. Such a further purpose may for example include the generation of a further braking action, in particular in the service brake system. Nevertheless, in embodiments, an outlet valve or the further outlet valve may be provided primarily and/or exclusively for the purposes of ventilating the at least one spring brake cylinder.

In an embodiment of the method, provision is made whereby, during the ventilation of the spring brake pressurization pressure, a pressure supply that provides a supply to the parking brake system is suspended, preferably by virtue of a compressor being deactivated and/or by virtue of a feed line being shut off. A suspension of the pressure supply that provides a supply to the parking brake system is intended to achieve that the ventilation of the at least one spring brake cylinder for the purposes of initiating the spring brake failsafe braking operation is as effective as possible, in particular as quick as possible, such that the spring brake cylinder remains in the ventilated state after the ventilating operation. In other words, it is intended to prevent new compressed air from being subsequently fed in to the ventilating or ventilated spring brake cylinder.

A deactivation of the compressor may preferably also be performed indirectly by virtue of the feed line being shut off, and thus by way of a pressure-controlled deactivation of the compressor. The suspension of the pressure supply that provides a supply to the parking brake system may be performed at the same time as, or within a tolerance time interval before and/or after, the ventilation of the spring brake pressurization pressure.

In various embodiments of the method, the suspension of the pressure supply may include a lowering of the reservoir pressure, preferably by virtue of the pressure reservoir being emptied. It is particularly preferable that, to lower the reservoir pressure, preferably to empty the pressure reservoir, the outlet valve and/or the further outlet valve is opened.

In an embodiment of the method, provision is made for the further outlet valve to be arranged in a brake circuit of the service brake system other than a brake circuit of the service brake system which initiates the service brake failsafe braking operation and/or maintains the spring brake failsafe braking operation. Nevertheless, in embodiments, provision may also be made for the further outlet valve to be arranged in that brake circuit which initiates the service brake failsafe braking operation, whereby, in particular, a braking action is additionally achieved via the service brake system upon the lowering of the reservoir pressure.

In a second aspect, to achieve the object, the disclosure furthermore specifies a fail-safety valve unit for a failsafe braking function of an electropneumatic brake system for a vehicle, preferably a utility vehicle, wherein the electropneumatic brake system includes a service brake system and a parking brake system having at least one spring brake cylinder, and wherein the fail-safety valve unit has: a valve main line, which pneumatically connects a main port and a failsafe brake port, and at least one failsafe brake valve which is configured as a monostable valve and which is arranged in the valve main line.

In the case of the fail-safety valve unit according to the second aspect of the disclosure, provision is made whereby the failsafe brake port is connectable or connected to a main circuit, which carries a service brake pressure, of the service brake system, the main port is pneumatically connectable or connected to the at least one spring brake cylinder, and the at least one failsafe brake valve, when not actuated, is open in a first position, such that ventilation of a spring brake pressurization pressure prevailing at the at least one spring brake cylinder is performed by a service brake ventilation function of the service brake system via the failsafe brake port in order to initiate a spring brake failsafe braking operation of the vehicle via the parking brake system.

In an embodiment of the fail-safety valve unit, provision is made for the spring brake pressurization pressure to additionally be provided, during the ventilation by the service brake ventilation function, as a service brake failsafe brake pressure for initiating a service brake failsafe braking operation.

The fail-safety valve unit is refined such that the at least one failsafe brake valve is actuatable by at least one control unit such that, in a fault event and/or in the event of an electrical failure and/or in a diagnostic event of the at least one control unit, a failsafe braking operation of the vehicle is initiated by the brake system by way of the ventilation of a spring brake pressurization pressure prevailing at the at least one spring brake cylinder and/or the provision of a service brake failsafe brake pressure at the failsafe brake port. In various embodiments, one failsafe brake valve is assigned to one control unit, that is, one failsafe brake valve is actuatable by one control unit. In other embodiments, it is also possible for multiple, in particular two, failsafe brake valves to be assigned to one control unit.

In an embodiment of the fail-safety valve unit, provision is made whereby the fail-safety valve unit has a first failsafe brake valve configured as a monostable valve and has a second failsafe brake valve configured as a monostable valve, wherein the first failsafe brake valve and the second failsafe brake valve are connected pneumatically in series in the valve main line, and the first failsafe brake valve is controllable by the first control unit and the second failsafe brake valve is controllable by the second control unit. The failsafe valve unit is refined to include a failsafe relay valve.

In a third aspect, to achieve the object, the disclosure furthermore specifies an electropneumatic brake system for a vehicle, in particular a utility vehicle, including a service brake system, a parking brake system and a control unit configured to carry out a method according to the first aspect of the disclosure.

In an embodiment of the electropneumatic brake system, a fail-safety valve unit according to the second aspect of the disclosure is provided, wherein the fail-safety valve unit is arranged in a separate actuation branch.

The electropneumatic brake system is refined to include a first control unit and a second control unit which are supplied with energy independently of one another and/or which can at least partially replace one another in terms of their function.

The electropneumatic brake system is refined such that a service brake air quantity that can be accommodated or ventilated by the service brake ventilation function is greater than or equal to a spring brake pressure air quantity that can be accommodated by at least one spring brake cylinder, in particular by all spring brake cylinders, of the parking brake system, such that the ventilation of the spring brake pressurization pressure by the service brake ventilation function results in complete ventilation of the at least one spring brake cylinder.

The electropneumatic brake system is refined such that the electropneumatic brake system, preferably the control unit or a vehicle bus or a further electronic control means, is configured to, during the ventilation of the spring brake pressurization pressure by a service brake ventilation function, suspend a pressure supply that provides a supply to the parking brake system, the suspension being implemented preferably by virtue of a compressor being deactivated and/or by virtue of a feed line being shut off and/or by virtue of the reservoir pressure being lowered. The further electronic control means may be formed in particular by a unit for autonomous driving.

In a fourth aspect, to achieve the object, the disclosure furthermore specifies a vehicle, in particular a utility vehicle, configured to carry out a method according to the first aspect of the disclosure and/or having a fail-safety valve unit according to the second aspect of the disclosure and/or having an electropneumatic brake system according to the third aspect of the disclosure.

It is to be understood that the method according to the first aspect of the disclosure, the fail-safety valve unit according to the second aspect of the disclosure, the electropneumatic brake system according to the third aspect of the disclosure and the vehicle according to the fourth aspect of the disclosure have identical and similar sub-aspects. In this respect, for the refinement of one aspect of the disclosure, reference is also made to the refinements of the other aspects of the disclosure.

### BRIEF DESCRIPTION OF DRAWINGS

The invention will now be described with reference to the drawings wherein:

FIG. 1 shows an embodiment of an electropneumatic brake system configured to carry out a method according to the disclosure;

FIG. 2A shows a first embodiment of a fail-safety valve unit;

FIG. 2B shows a second embodiment of a fail-safety valve unit;

FIG. 2C shows a third embodiment of a fail-safety valve unit;

FIG. 2D shows a fourth embodiment of a fail-safety valve unit;

FIG. 3 shows a further embodiment of an electropneumatic brake system having a fail-safety valve unit;

FIG. 4 shows a pneumatic circuit diagram of an axle modulator for illustrating a possible service brake ventilation function; and,

FIG. 5 shows schematic profiles of the control signal, of the spring brake pressurization pressure, of a reservoir pressure and of an optional service brake pressure.

### DETAILED DESCRIPTION

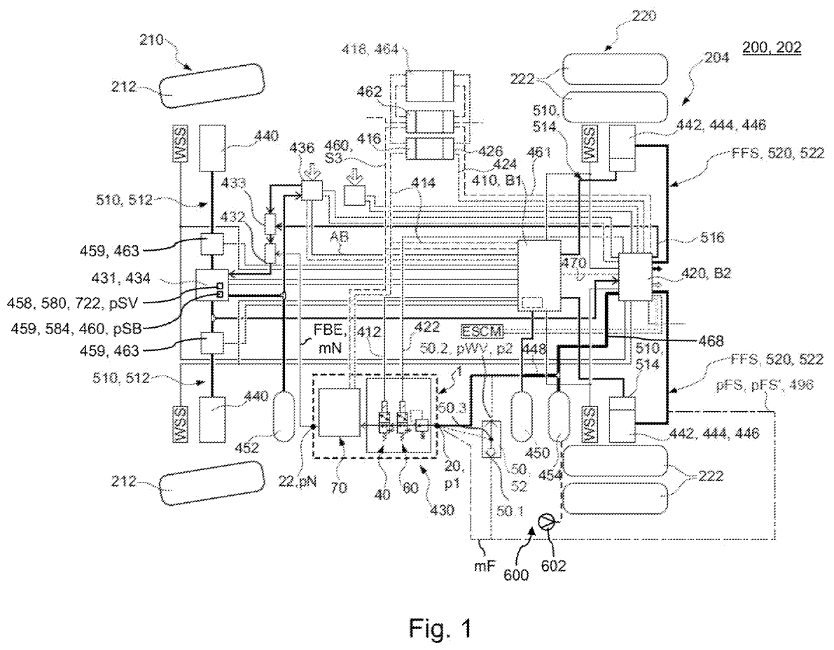

FIG. 1 shows an electropneumatic brake system 204 having a fail-safety valve unit 1 according to the disclosure. The electronically controllable pneumatic brake system 204 is used in the present case in a vehicle 200 configured as a utility vehicle 202, which is illustrated here in highly schematic form, in particular with two front wheels 212 on a front axle 210 and four rear wheels 222 on a rear axle 220.

A primary system B1 of the electropneumatic brake system 204 is controlled via a first control unit 410. A first fall-back level B2 of the electropneumatic brake system 204 is controlled via a second control unit 420. The first control unit 410 has an energy-conducting connection to a first energy supply 416 via a first supply line 414. The second control unit 420 has an energy-conducting connection to a second energy supply 426 via a second supply line 424.

The first control unit 410 is configured to supply compressed air from a further pressure reservoir 452 to a pneumatic front-axle circuit 512 of a service brake system 510 of the electropneumatic brake system 204, in order to actuate at least one service brake cylinder 440 that is assigned to a front wheel 212, by electronically actuating an electronically actuated brake signal transmitter 436 and/or a front-axle modulator 434. The first control unit 410 is furthermore configured to actuate in each case one service brake chamber 444 of at least one spring brake cylinder 442, which is assigned to a rear wheel 222, via a pneumatic rear-axle circuit 514 by way of pneumatic actuation. Here, the compressed air for the pneumatic rear-axle circuit 514 is provided from a yet further pressure reservoir 450.

The second control unit 420 is configured to actuate a parking brake chamber 446 of a spring brake cylinder 442, which is assigned to the relevant rear wheel 222, via a pneumatic rear-axle circuit 522 of a parking brake system 520 by providing a spring brake pressurization pressure pFS. Here, the compressed air for the parking brake system 520 is provided from a pressure reservoir 454. The second control unit 420 is furthermore configured to pneumatically actuate the front-axle modulator 434 via a redundancy circuit 516 of the service brake system 510 and a further front-axle shuttle valve 433, and to thereby pneumatically actuate the pneumatic front-axle circuit 512 of the service brake system 510 with the service brake cylinders 440. The second control unit 420 is thus configured to brake not only the rear wheels 222 but also the front wheels 212 of the vehicle 200, whereby the second control unit is in particular suitable for serving as a control unit for the first fall-back level B2.

The first control unit 410 and the second control unit 420 are connected to one another, preferably for bidirectional transmission of signals, via a signal connection 470 via a bus.

The main port 20 of the fail-safety valve unit 1 is pneumatically connected to the parking brake system 520. As illustrated here by dash-dotted lines, the main port 20 is particularly advantageously pneumatically connected via a pneumatic parking brake line 496 of the parking brake system 520 to the parking brake system 520 for the purposes of ventilating the spring brake pressurization pressure pFS. The spring brake pressurization pressure pFS can thus be ventilated via the parking brake line 496 and the fail-safety valve unit 1 and further via a brake circuit 512, 514 of the service brake system 510. Alternatively or in addition, the main port 20 may be configured to ventilate a pressure pFS′ derived from the parking brake pressure pFS.

The service brake ventilation function FBE advantageously includes the opening of an outlet valve 458 and/or of a further outlet valve 459. An outlet valve 458 may be arranged in a pilot-control circuit 580, which carries a service brake pilot-control pressure pSV, of the service brake system 510. The outlet valve 458 is advantageously arranged in an axle modulator 431. Here, by way of example, a pilot-control ventilation valve 722 of the front-axle modulator 434 is schematically shown as an outlet valve 458. A further outlet valve 459 may be arranged in a main circuit 584, which carries a service brake pressure pSB. The further outlet valve 459 may advantageously be arranged in an axle modulator 431 or else in a further pneumatic component such as an ABS valve 463. Here, by way of example, the further outlet valve 459 is schematically shown as a pneumatic main valve 460 of the front-axle modulator 434. Alternatively or in addition, the further outlet valve 459 may be configured as an ABS valve 463, as is also schematically shown here.

In further advantageous embodiments, the fail-safety valve unit 1 may have a selector valve 50, which is configured in particular as a shuttle valve 52. The selector valve 50 is configured to pneumatically connect that one of a first selector valve port 50.1 and a second selector valve port 50.2 at which the higher pressure prevails to a third selector valve port 50.3.

In particular, in embodiments with a selector valve 50, a reservoir pressure pV may be provided at the second valve port 50.2 from a further compressed-air source, in particular from the pressure reservoir 454, from a further pressure reservoir 452 or from a yet further pressure reservoir 450. In the present case, by way of example, a dotted line is used to illustrate a pneumatic connection between the second selector valve port 50.2 and the pressure reservoir 454. Via the selector valve 50, it can advantageously be ensured that the pressure prevailing at the main port 20 is either the parking brake pressure pFS or the reservoir pressure pV, depending on which selector valve port 50.1, 50.2 the higher pressure prevails at. Redundancy is advantageously achieved in this way in the event that no compressed air is available at one of the two selector valve ports 50.1, 50.2, for example owing to a leak or a system failure. In embodiments, provision may be made whereby the main port 20 is connected to the reservoir line 448 not directly, as shown here, but only via the selector valve 50. Also, in yet further embodiments, provision may be made whereby the main port 20 is connected only to the parking brake line 496, and in particular not to any pressure reservoir 450, 452, 454.

In embodiments in which, in particular, a reservoir pressure pV is provided via a selector valve 50, measures for lowering the reservoir pressure pV are advantageously provided in order to achieve ventilation of the spring brake pressurization pressure pFS. These measures may advantageously include the suspension of a pressure supply 600 that provides a supply to the parking brake system 520, preferably by virtue of a compressor 602 being deactivated and/or by virtue of a feed line 468 being shut off and/or by virtue of the reservoir pressure pV being lowered. A deactivation of the compressor 602 may also be performed indirectly by virtue of the feed line 468 being shut off, and thus by way of a pressure-controlled deactivation of the compressor 602. The feed line 468 may be shut off via a valve that is not shown here. The reservoir pressure pV may advantageously be lowered by virtue of at least one pressure reservoir 450, 452, 454 being emptied.

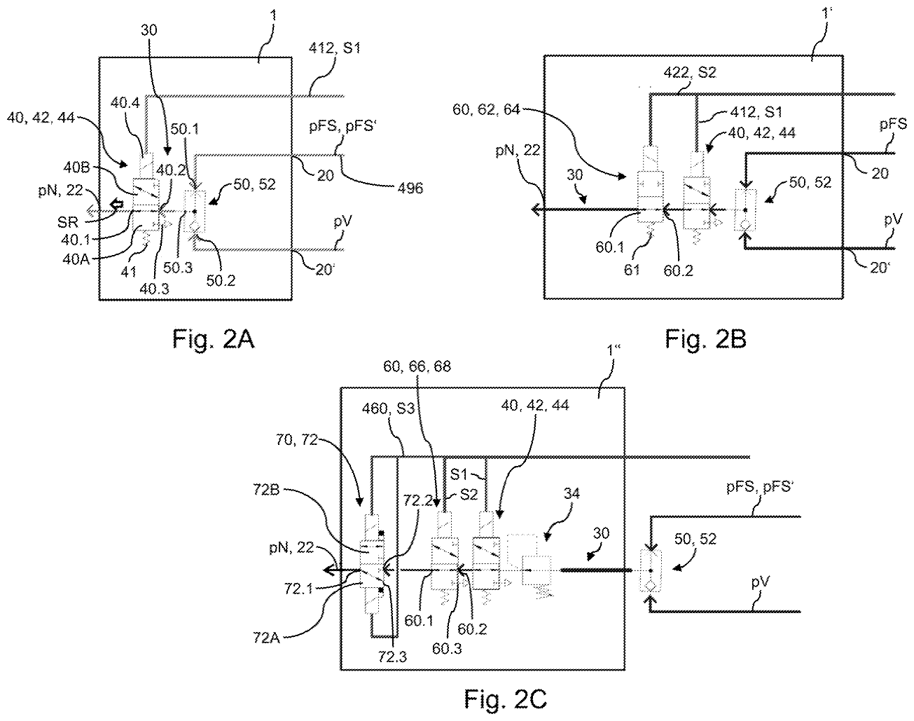

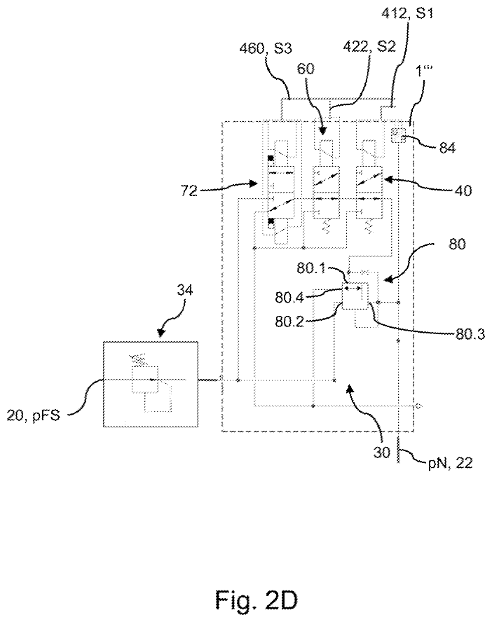

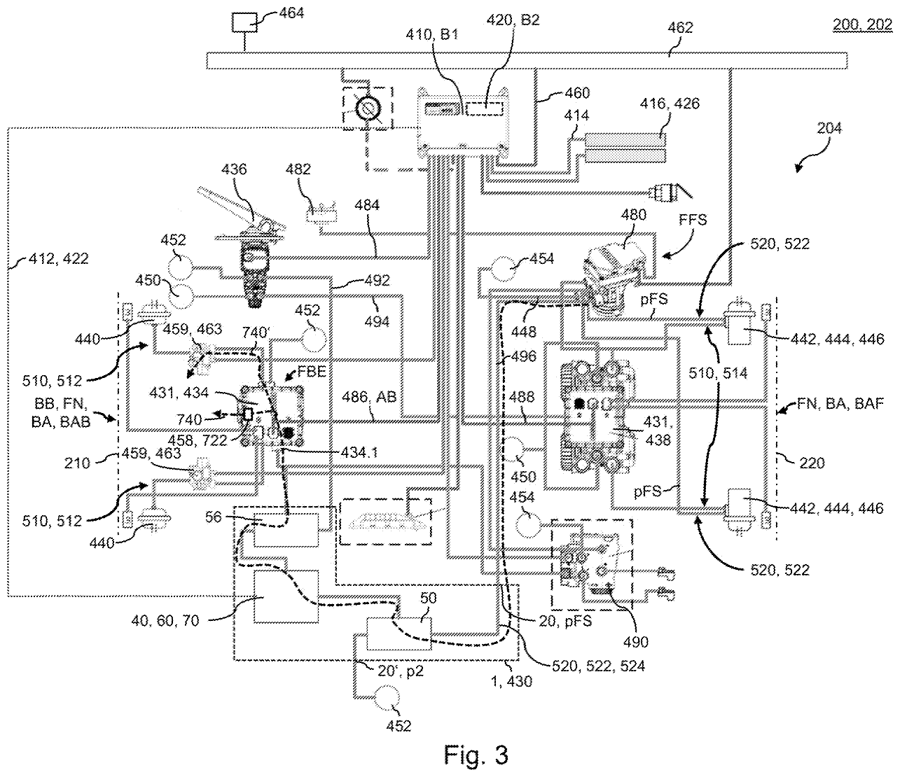

The selector valve 50 and the provision of a reservoir pressure pV are to be regarded as being optional; this applies in particular to the embodiments shown in FIG. 1, FIG. 2A, FIG. 2B, FIG. 2C and FIG. 3.

In advantageous embodiments, in addition to the ventilation of the at least one spring brake cylinder 442 by the service brake ventilation function FBE, the spring brake pressurization pressure pFS conducted through the fail-safety valve unit 1 may be provided via the failsafe brake port 22 as a service brake failsafe brake pressure pN for initiating a service brake failsafe braking operation BAB.

The fail-safety valve unit 1 furthermore has a bistable valve unit 70 which is supplied with energy via the first supply line 414 and which is connected via a vehicle bus line 460 to a first vehicle bus 462. The first vehicle bus 462 is furthermore connected via the vehicle bus line 460 to the first control unit 410. The first vehicle bus 462 is in the present case connected via a further vehicle bus line 461 to the second control unit 420.

The bistable valve unit 70, having a bistable valve 72 that is not shown here, has the characteristic of not being directly influenced by a fault event, in particular in the event of a double fault FD, because, owing to its bistable characteristic, it remains in the particular position into which it has previously been switched.

By contrast, the first failsafe brake valve 40 and the second failsafe brake valve 60, owing to their monostable behavior, have the characteristic of returning into one position, in the present case into the first position 40A, 60A in each case, in an electrically deenergized state. In this way, according to the concept of the disclosure, automatic switching of the failsafe brake valves 40, 60 into their first position 40A, 60A can be achieved in a situation in which no control signal S1, S2 is present, or the control signal S1, S2 is present as a zero signal, both at the first failsafe brake valve 40 and at the second failsafe brake valve 60. Such a situation with an absence of a control signal S1, S2, or with a zero signal, arises in particular in the event of an exceptional fault FA or electrical failure FS in the control units 410, 420.

When the bistable valve 72 is situated in its second position 72B, this is advantageously suitable for an automatic, in particular autonomous driving mode of the vehicle 200, because in this case, a pneumatic connection is produced between the first and the second bistable valve port 72.1, 72.2, and in this way—in the event of a return of the electrically deenergized first and second failsafe brake valves 40, 60 to their first position 40A, 60A—ventilation of the at least one spring brake cylinder 442 takes place, and/or a service brake failsafe brake pressure pN is provided at the failsafe brake port 22 for the purposes of braking the vehicle 200. In an automatic, in particular autonomous driving mode, the vehicle 200 may be controlled via a unit 464 for autonomous driving, which has a signal-conducting connection to the first vehicle bus 462.

When the bistable valve 72 is situated in its first position 72A, this is advantageously suitable for a manual driving mode of the vehicle 200. In this case, a shut-off of the valve main line 30 prevents a braking operation from being performed, as a result of the at least one spring brake cylinder 442 being ventilated and/or as a result of a failsafe brake pressure pN being provided at the failsafe brake port 22, in the event of a double fault FD.

The service brake ventilation function FBE is advantageously configured for accommodating and/or for ventilating a service brake air quantity mN that is greater than or equal to a spring brake pressure air quantity mF. The spring brake pressure air quantity mF corresponds to the air quantity which can be accommodated by the at least one spring brake cylinder 442 and which has to be ventilated for the parking brake failsafe braking operation BAF.

When the service brake failsafe brake pressure pN is provided at the failsafe brake port 22, the service brake failsafe brake pressure pN passes via a front-axle shuttle valve 432 and a front-axle modulator 434 to two service brake cylinders 440 that are assigned to one front wheel 212 each. The service brake cylinders 440 are actuated by being pressurized with the service brake failsafe brake pressure pN, resulting in braking of the front wheels 212.

The fail-safety valve unit 1 is advantageously arranged in a separate actuation branch 430 of the electropneumatic brake system 204, which is provided independently of the regular actuation of the service brake cylinders 440, in particular via a brake signal transmitter 436 and/or the spring brake cylinder 442. In general, it is also possible for a service brake failsafe brake pressure pN to be provided for another brake cylinder, for example to the service brake chambers 444 of the spring brake cylinders 442 assigned to the rear wheels 222.

A diagnostic procedure AD for checking the functioning of the fail-safety valve unit 1 may advantageously be carried out in a diagnostic event FT by an electronic control unit, in particular the control unit 410 or an external control unit 418, in particular a unit 464 for autonomous driving. In particular, the external control unit 418 has a signal-conducting connection to the control units 410, 420, in particular via a vehicle bus line 460, 461, in order to monitor the control units. The external control unit 418 may in particular advantageously be formed by another electronic control unit of the vehicle 200 or as part of another electronic control unit of this type. Another electronic control unit of this type, in particular the external control unit 418, may in particular be a unit 464 for autonomous driving, an electronic control unit of a steering system, an electronic control unit of a parking brake system, and/or an electronic control unit of an air treatment system. A unit 464 for autonomous driving may in particular be a so-called virtual driver, which generates driving commands on the basis of sensor data, operating data, route data, setpoint data and similar data, and provides the driving commands to the vehicle. Driving commands may include steering commands, acceleration commands and braking commands, in particular a braking demand AB.

FIG. 2A shows a first embodiment of a fail-safety valve unit 1 in detail. The fail-safety valve unit 1 has a monostable failsafe brake valve 40. The failsafe brake valve 40 has a signal-conducting and energy-conducting connection to the control unit 410 via a control line 412.

The failsafe brake valve 40 is illustrated here in a non-actuated and electrically deenergized state, in which it is in a first position 40A. In the first position 40A, a pneumatic connection is produced between a first valve port 40.1 and a second valve port 40.2 of the failsafe brake valve 40. When the failsafe brake valve 40 is in the first position 40A, the spring brake pressurization pressure pFS of at least one spring brake cylinder 442 is to be ventilated via the main port 20 and the failsafe brake port 22 and preferably provided as a service brake failsafe brake pressure pN.

By virtue of a control signal S1 being provided via the control line 412, the failsafe brake valve 40 can be switched from the first position 40A into a second position 40B counter to the resistance of a restoring spring 41. In the second position 40B, a pneumatic connection is produced between the first valve port 40.1 and a ventilation port 40.3. In particular, provision is made for the failsafe brake valve 40 to be in its second position 40B during normal operation of the vehicle 200. In this state, there is therefore no pneumatic connection between the main port 20 and the failsafe brake port 22, because the pneumatic connection has been shut off at the failsafe brake valve 40.

In a fault event FF, in particular in the absence of a control signal S1, and thus if a magnet part 40.4 of the failsafe brake valve 40 is electrically deenergized, the failsafe brake valve 40 automatically returns to its first position 40A owing to the restoring force generated by the restoring spring 41.

Such a fault event FF may for example be an electrical failure FS, if the control unit 410 is not being supplied with energy. In the event of such an electrical failure, it is correspondingly the case that no control signal S1 is transmitted to the failsafe brake valve 40.

Furthermore, a fault event FF may also consist in an exceptional fault FA occurring in the control unit 410, and a zero signal being output by the control unit 410 as a fault measure (in particular in the absence of other program alternatives), and the control signal S1 thus being intentionally set to 0 in order to switch the failsafe brake valve 40 into the first position 40A.

A diagnostic event FT may be initiated, preferably by the control unit 410 or an external control unit 418, in order to check the functioning of the fail-safety valve unit. The diagnostic event FT may be initiated as part of a diagnostic procedure. In particular, in a diagnostic event FT, an actuation of the failsafe brake valves is interrupted by virtue of the provision of the control signal S1, S2 being ended.

FIG. 2B shows a further embodiment of a fail-safety valve unit 1′ according to the disclosure. By contrast to the embodiments shown in FIG. 2A, the fail-safety valve unit 1′ shown here has a further failsafe brake valve 60, which is arranged in the valve main line 30 and which is connected pneumatically in series with the failsafe brake valve 40. The further failsafe brake valve 60 is configured here as a 2/2 directional valve 62, in particular as a 2/2 directional solenoid valve 64.

In other embodiments, the further failsafe brake valve 60 may likewise be configured as a 3/2 directional valve 66, in particular as a 3/2 directional solenoid valve 68, as shown by way of example in FIG. 2C. The further failsafe brake valve 60 is in particular of monostable configuration, such that it is in a further first position 60A when in the non-actuated, in particular electrically energized state. In particular, the further failsafe brake valve 60 has a further restoring spring 61, which moves the further failsafe brake valve 60, when in the non-actuated state, into the further first position 60A. In the further first position 60A, a first further valve port 60.1 of the further failsafe brake valve 60 is pneumatically connected to a second further valve port 60.2 of the further failsafe brake valve 60. The further failsafe brake valve 60 is in particular actuated by way of a further control signal S2 via a further control line 422, in particular from the control unit 410 or a further control unit 420.

An embodiment with a further failsafe brake valve 60 is advantageous in particular in the case of an optional brake system 204 that has a further control unit 420 or similar redundant control device. In particular, in such a brake system 204, the control unit 410 is assigned to a primary system B1, and the further control unit 420 is assigned to a first fall-back level B2. In a fault event FF in the primary system B1, in particular in the control unit 410, it thus remains possible, via the still-intact fall-back level B2, for the fail-safety valve unit 1′ to be actuated, and in particular for a ventilation of the at least one spring brake cylinder 442 and/or a provision of the failsafe brake pressure pN to be withheld by way of sustained actuation of the further failsafe brake valve 60 in the further second position 60B. Via a further failsafe brake valve 60 configured as a 2/2 directional solenoid valve 64, it remains possible—advantageously in embodiments with a functionality for initiating a service brake failsafe braking operation BAB—for the service brake failsafe brake pressure pN to be modulated. In this way, staged braking is advantageously made possible, in particular via a redundancy port 718, even in the event of a partial failure, in particular if a primary system B1 has failed, and braking functionality is advantageously ensured by the fail-safety valve unit 1 by way of the separate actuation branch.

In the event of a double fault FD, that is, if a fault event FF, in particular in the form of an exceptional fault FA and/or an electrical failure FS, occurs both in the control unit 410 and in the further control unit 420, both the failsafe brake valve 40 and the further failsafe brake valve 60, owing to their monostable behavior, each switch into their first position 40A, 60A in order to the at least one spring brake cylinder 442 and/or provide a service brake failsafe brake pressure pN at the failsafe brake port 22.

FIG. 2C illustrates a yet further embodiment of a fail-safety valve unit 1″. By contrast to the embodiment shown in FIG. 2B, the fail-safety valve unit 1″ has a bistable valve 72. As a further difference in relation to the embodiment shown in FIG. 2B, the further failsafe brake valve 60 is configured in the present case as a 3/2 directional valve 66, in particular as a 3/2 directional solenoid valve 68. The failsafe brake valve 40 and the further failsafe brake valve 60 are advantageously structurally identical, as shown here. The further failsafe brake valve 60 configured as a 3/2 directional valve 66 advantageously has, as shown here, a further ventilation port 60.3, which in the second position 60B is connected to the first further valve port 60.1. Via the further ventilation port 60.3, the failsafe brake port 22 can advantageously be ventilated when the further failsafe brake valve 60 has been switched into its second position 60B.

It is advantageously possible in all embodiments for a pressure-limiting valve 34 to be arranged in the valve main line 30, as illustrated in FIG. 2C. A pressure-limiting valve 34 can be used to set a predefined air pressure with which the service brake failsafe brake pressure pN is provided at the failsafe brake port 22, in order to achieve a suitable braking action for the vehicle during the service brake failsafe braking operation.

In optional further embodiments—by contrast to that shown in FIG. 2C—the further failsafe brake valve 60 is likewise actuated jointly with the failsafe brake valve 40 by way of the control signal S1. In particular, the further failsafe brake valve 60 may be actuated jointly with the failsafe brake valve 40 via the control line 412, in particular may be actuated jointly with the failsafe brake valve 40 by the control unit 410. An arrangement of multiple failsafe brake valves 40, 60, in particular an arrangement with a failsafe brake valve 40 and a further failsafe brake valve 60, has the advantage of redundancy in the event of a valve fault, in particular in the event of a mechanical or electrical valve fault, at one of the failsafe brake valves 40, 60. For example, if one of the failsafe brake valves 40, 60 can no longer be actuated, and moved from the first position 40A, 60A into the second position 40B, 60B, owing to jamming or a defective magnet part, the vehicle would inadvertently assume a state of a failsafe braking operation BA induced by the fail-safety valve unit 1″. This unintended state can be eliminated and/or prevented via the further, still-functioning failsafe brake valve.

In the present case, the bistable valve 72 is arranged in the valve main line 30. It is advantageously possible in all embodiments for a bistable valve 72 to be arranged in the valve main line 30, as illustrated in FIG. 2C, in particular also in the embodiments shown in FIG. 2A and FIG. 2B.

In particular, the bistable valve 72 has a signal-conducting and/or energy-conducting connection to a controller, in particular the control unit 410 or a further control unit 420 or a yet further control unit that is not shown here, via a yet further control line 460, and is controllable by way of a third control signal S3. The bistable valve 72 has the characteristic of not being directly influenced by a fault event FF because, owing to its bistable characteristic, it remains in a position into which it has previously been switched.

By contrast, the failsafe brake valve 40 and the further failsafe brake valve 60, owing to their monostable behavior, have the characteristic of returning into one position, in the present case into the first position 40A, 60A in each case, in an electrically deenergized state. In this way, according to the disclosure, automatic switching of the failsafe brake valves 40, 60 into their first position 40A, 60A can be achieved in a situation in which no control signal S1, S2 is present, or the control signal S1, S2 is present as a zero signal, at the failsafe brake valve 40 and in particular also at the further failsafe brake valve 60. Such a situation with an absence of a control signal S1, S2, or with a zero signal, arises in particular in the event of an exceptional fault FA or electrical failure FS in the control units 410, 420.

When the bistable valve 72 is situated in its second position 72B, this is preferably suitable for an automatic, in particular autonomous driving mode of the vehicle 200, because in this case, a pneumatic connection is produced between a first and a second bistable valve port 72.1, 72.2, and in this way—in the event of a return of the failsafe brake valves 40, 60 to their first position 40A, 60A—ventilation of the spring brake pressurization pressure pFS takes place for the spring brake failsafe braking operation BAF, and/or a service brake failsafe brake pressure pN is provided at the failsafe brake port 22 for a service brake failsafe braking operation BAB. In an automatic, in particular autonomous driving mode, the vehicle 200 may be controlled for example via a unit 464 for autonomous driving, which has a signal-conducting connection to the vehicle data bus 462.

When the bistable valve 72 is situated in its first position 72A, this is suitable in particular for a manual driving mode of the vehicle 200. In this case, a shut-off of the valve main line 30 prevents a spring brake failsafe braking operation BAF and/or a service brake failsafe braking operation BAB from being performed in a fault event FF, in particular in the event of a double fault FD.

FIG. 2D illustrates a yet further embodiment of a fail-safety valve unit 1′″ with a pressure sensor 84. In the present case, the pressure sensor 84 is arranged at the failsafe brake port 22 and is configured to measure the provided failsafe brake pressure pN. Via a pressure sensor 84, the pressure reaction and thus the functioning of the fail-safety valve unit 1 can be checked for plausibility and/or inspected. Such a pressure sensor 84 may be provided in all embodiments.

A failsafe relay valve 80, as illustrated in FIG. 2D, may also be provided in all embodiments. The failsafe relay valve 80 has a failsafe control port 80.1, a failsafe reservoir port 80.2, a failsafe working port 80.3 and a failsafe ventilation port 80.4. The failsafe reservoir port 80.2 is pneumatically connected to the main port 20. The failsafe control port 80.1 is connected to the valve main line 30 such that the valve main line including all failsafe brake valves 40, 60 and any bistable valves 72 form the control line of the failsafe relay valve 80. The failsafe working port 80.3 is pneumatically connected to the failsafe brake port 22. The failsafe relay valve 80 has the effect of boosting an air flow rate, whereby the air flow rates that have to be switched by the failsafe brake valves and optionally by the bistable valve are advantageously lower, and the valves can therefore be dimensioned to be smaller, and/or are subjected to lower load. At the same time, a relatively large air mass flow can be conducted via the failsafe reservoir port 80.2 for the purposes of quickly dissipating the spring brake pressurization pressure pFS.

FIG. 3 shows an electropneumatic brake system 204 having a fail-safety valve unit 1 for a failsafe braking function FN according to the disclosure. The failsafe braking function FN advantageously includes a spring brake failsafe braking operation BAF and/or a service brake failsafe braking operation BAB. The electropneumatic brake system 204 is used in the present case in a vehicle 200 configured as a utility vehicle 202, which is illustrated here in highly schematic form, in particular with an indicated front axle 210 and an indicated rear axle 220.

The electropneumatic brake system 204 is controlled via a control unit 410. The control unit 410 has an energy-conducting connection to an energy supply 416 via a supply line 414.

In order to receive brake signals, the control unit 410 has an electrically signal-conducting connection to a brake signal transmitter 436 via a brake signal transmitter control line 484. The control unit 410 is furthermore configured to actuate a front-axle modulator 434, via an electrically signal-conducting front-axle modulator control line 486, in a manner dependent on the brake signals or in a manner dependent on any driving programs of a unit 464 for autonomous driving in an automatic driving mode. In particular, a braking operation can be initiated via the front-axle modulator control line 486 an electrical or electronic braking demand AB placed on the axle modulator 431. An electronic braking demand AB may in particular be in the form of a CAN and/or XBR command. The front-axle modulator 434 is configured to supply compressed air from a further compressed-air reservoir 452 to a pneumatic front-axle brake circuit 512 of a service brake system 510 of the electropneumatic brake system 204 in a manner dependent on this actuation, in order to actuate at least one service brake cylinder 440, which is assigned to a front wheel 212, to perform a service braking operation BB. The control unit 410 is furthermore configured to actuate in each case one service brake chamber 444 of at least one spring brake cylinder 442, which is assigned to a rear wheel 222, via a pneumatic rear-axle brake circuit 514 by way of pneumatic actuation. The control unit 410 has an electrically signal-conducting connection to a rear-axle modulator 438 via a rear-axle modulator control line 488. The compressed air for the pneumatic rear-axle brake circuit 514 is provided here from a yet further pressure reservoir 450 and is conducted via the rear-axle modulator 438, when actuated by the control unit 410, to the service brake chambers 444. The control unit 410 is thus configured to brake both the front wheels 212 and the rear wheels 222 of the vehicle 204. The front-axle modulator control line 486 and/or the rear-axle modulator control line 488 are configured in particular as vehicle data bus lines, in particular CAN lines.

The brake system 204 has a parking braking function FFS with a parking brake module 480. The parking braking function FFS is preferably implemented via a parking brake system 520 and/or the parking brake module 480. Via the parking braking function FFS, a spring brake pressurization pressure pFS can be output in order to pressurize parking brake cylinders 442. Accordingly, the parking braking function FFS preferably includes a parking brake module 480. The parking brake module 480 of the brake system 204 is configured to actuate a parking brake chamber 446 of one of the two parking brake cylinders 442, which are each assigned to the rear wheel 222, via a pneumatic rear-axle brake circuit 522 of the parking brake system 520, in particular via a pneumatic parking brake line 496, by way of an output spring brake pressurization pressure pFS. The parking brake module 480 has an electrically signal-conducting connection to a parking brake operator control element 482. The pneumatic rear-axle brake circuit 522 of the parking brake system 520 can thus be activated and deactivated via the parking brake operator control element 482. The parking brake module 480 is pneumatically connected via a reservoir line 448 to the pressure reservoir 454 in order to be supplied with compressed air.

The rear-axle modulator 438 has a signal-conducting connection to the control unit 410 via the rear-axle modulator control line 488. Here, the compressed air for the parking brake system 520 is provided from a pressure reservoir 454.

The brake signal transmitter 436 is pneumatically connected via a pneumatic front-axle modulator control line 492 to a pneumatic control port 434.1, in particular a redundancy port 718, of the front-axle modulator 434 in order to actuate the pneumatic front-axle brake circuit 512. The front-axle modulator 434 is in particular configured such that, when pneumatically pressurized via the front-axle modulator control line 492, it outputs a brake pressure to the service brake cylinders 440. The brake signal transmitter 436 is—analogously to the front-axle modulator 434—pneumatically connected via a pneumatic rear-axle modulator control line 494 to the rear-axle modulator 438 in order to actuate the pneumatic rear-axle brake circuit 514. The rear-axle modulator 438 is in particular configured such that, when pneumatically pressurized via the pneumatic rear-axle modulator control line 494, it outputs a brake pressure to the service brake cylinders 444. In particular, the front-axle modulator 434 and/or the rear-axle modulator 438 have a relay valve for outputting a brake pressure.

The main port 20 of the fail-safety valve unit 1 is pneumatically connected via the pneumatic parking brake line 496 to the parking brake module 480 and to the pneumatic rear-axle brake circuit 522 of the parking brake system 520. A further selector valve 56 is advantageously arranged in the pneumatic front-axle modulator control line 492 in order to pneumatically connect the failsafe brake port 22 to a control input of the front-axle modulator 434.

The failsafe brake valve 40 has a signal-conducting and energy-conducting connection to the control unit 410 via a control line 412. The vehicle 200 may have a further pressure control device 489, in this case in the form of a trailer control module 490 for providing a pneumatic supply to a trailer (not illustrated here) of the vehicle 200.

When the at least one failsafe brake valve 40, 60 is switched into its first position 40A, 60A, the spring brake cylinders 442 are ventilated in order to initiate a spring brake failsafe braking operation BAF of the vehicle 200. In this regard, the service brake ventilation function FBE provided via the front-axle modulator 434 is schematically indicated by the depiction of a ventilation path 740 using dashed lines. This is implemented in the present case via a pilot-control ventilation valve 722 as an outlet valve 458. In other embodiments, the provided service brake ventilation function FBE may alternatively or additionally be implemented via a further outlet valve 459, in particular via an ABS valve 463, as shown here by way of example by a further ventilation path 740′.

Furthermore, when a service brake failsafe brake pressure pN is provided at the failsafe brake port 22, the service brake failsafe brake pressure pN preferably passes to the front-axle modulator 434, whereby the front-axle modulator 434 pneumatically actuates two service brake cylinders 440 that are each assigned to the front axle 210. The service brake cylinders 440 are thus actuated by virtue of the service brake failsafe brake pressure pN being applied to the front-axle modulator 434, whereby a service brake failsafe braking operation BAB of the front axle 210 and thus of the vehicle 200 is achieved. The fail-safety valve unit 1 is arranged in a separate actuation branch 430 of the electropneumatic brake system 204, which is provided independently of the regular actuation of the service brake cylinders 440, in particular via a brake signal transmitter 436. It is nevertheless also possible in the context of the disclosure for a service brake failsafe brake pressure pN to be provided directly to at least one service brake cylinder 440, or for another brake cylinder, for example to the service brake chamber 444 of the parking brake cylinders 442 assigned to the rear wheels 222. In particular, in order to increase the independence of the fail-safety valve unit 1 and thus advantageously provide a redundant failsafe braking functionality, the pressure reservoir 454 that provides a supply to the parking brake module 480 is separate from a further pressure reservoir 452 that provides compressed air for the service brake cylinders 440 during normal operation.

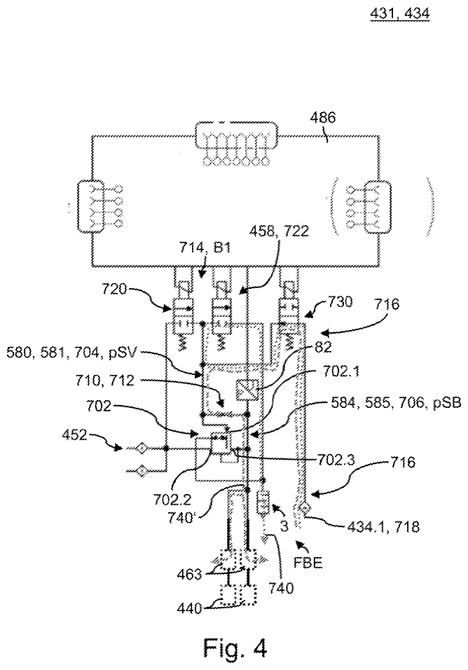

FIG. 4 shows a pneumatic circuit diagram of an axle modulator 431, in particular of a front-axle modulator 434. The axle modulator 431 has a pilot-control circuit 580 in the form of an axle modulator pilot-control circuit 581, and a main circuit 584 in the form of an axle-modulator main circuit 585. The axle modulator 431 has a relay valve 702, to which a service brake pilot-control pressure pSV can be applied via a control line 704 and a valve control port 702.1 of the axle modulator pilot-control circuit 581 in order to output a service brake pressure pSB at a working port 702.3 of the axle modulator main circuit 585. Compressed air is provided to the relay valve 702, in particular from a further pressure reservoir 452, via a reservoir port 702.2. The working port 702.3 is in particular pneumatically connected to the service brake cylinders 440 of the front axle 210 via a working line 706. The control line 704 has an electrical actuation branch 714 with a pilot-control pressurization valve 720 and a pilot-control ventilation valve 722, which is configured to pressurize and/or ventilate the valve control port 702.1. The electrical actuation branch 714 with the pilot-control pressurization valve 720 and the pilot-control ventilation valve 722 is controllable in particular via the control unit 410 and/or the primary system B1, in particular via the front-axle modulator control line 486. The axle modulator pilot-control circuit 581 has a pneumatic actuation branch 716 with a backup valve 730. The valve control port 702.1 is pneumatically connected via the pneumatic actuation branch 716 to a control port 434.1. The control port 434.1 is configured in particular as a redundancy port 718 of the front-axle modulator 434. The backup valve 730 is configured in particular as a 2/2 directional valve and to be of monostable, normally-open configuration so as to open, and allow pneumatic actuation via the pneumatic actuation branch 716, in the absence of actuation in a fault event FF. The pilot-control pressurization valve 720 and the pilot-control ventilation valve 722 of the electrical actuation branch 714 are in particular configured correspondingly as 2/2 directional valves and to be of monostable, normally-closed configuration. The axle modulator 431 has an axle modulator pressure sensor 82, which in this case is arranged in the working line 706 in order to measure the service brake pressure pSB.

In the present case, the front-axle modulator 434 has a throttle 710, in particular a dissipation bore 712, which pneumatically connects the working line 706 to the control line 704. The throttle 710 has a reduced nominal size in relation to the control line 704 and/or the working line 706.

The throttle 710 is in particular arranged in a relay piston of the relay valve 702, in particular as a dissipation bore 712 in the relay piston.

In various embodiments, the pneumatic actuation branch 716 is pneumatically connected, in particular via the control port 434.1 or the redundancy port 718, to the failsafe brake port 22 of the fail-safety valve unit 1. In such embodiments, the pilot-control ventilation valve 722 may be configured as an outlet valve 458 for the service brake ventilation function FBE. The opening of the pilot-control ventilation valve 722 causes a ventilation path 740 to be opened, via which the spring brake pressurization pressure pFS of the at least one spring brake cylinder 422 can thus be ventilated via the pilot-control circuit of the axle modulator 431 to a ventilation port 3. The ventilation path 740 is illustrated here using dotted lines.

In various embodiments, as an alternative or in addition to the illustrated ventilation path 740, the ventilation may take place via an ABS valve 463, as shown here as a further ventilation path 740′ using dashed lines. The further ventilation path 740′ particularly preferably leads via the throttle 710, as shown here.

The statements made here with regard to the front-axle modulator 434 may equally also apply, in other embodiments of the disclosure, to another axle modulator 431, for example a rear-axle modulator 438.

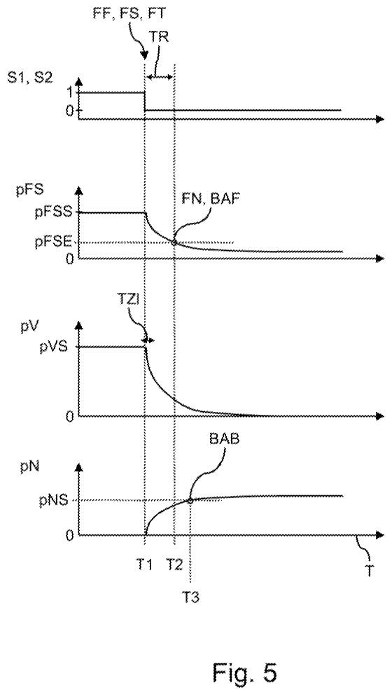

FIG. 5 schematically illustrates profiles of the control signal S1, of the optional further control signal S2, and of the spring brake pressurization pressure pFS, of a reservoir pressure pV, and of an optional service brake pressure pSB or failsafe brake pressure pN.

At a time T1, the control signal S1, and in optional embodiments also the further control signal S2, is interrupted or withdrawn or set to zero. This is caused in particular by a fault event FF and/or an electrical failure FS and/or a diagnostic event FT of the control unit 410, 420.

The at least one failsafe brake valve 40, 60 of the fail-safety valve unit 1 consequently switches into a first position 40A, 60A, whereby at least one spring brake cylinder 442 is ventilated via the fail-safety valve unit 1. As a result, starting at the first time T1, the spring brake pressurization pressure pFS begins to decrease from a setpoint pressurization pressure pFSS. When the decreasing spring brake pressurization pressure pFS has reached an engagement pressurization pressure pFSE, the at least one spring brake cylinder 442 engages, thus initiating a failsafe braking function FN in the form of a spring brake failsafe braking operation BAF. The vehicle 200 safely comes to a stop.

Optionally, measures for shutting off the pressure supply 600 may advantageously be provided, in particular in order to lower the reservoir pressure. This is shown here by way of example by the profile of a reservoir pressure PV which is reduced at the first time T1, or in a tolerance time interval TZI before and/or after the first time T1, for example by virtue of an outlet valve and/or a further outlet valve being opened. In addition to this, a compressor 602 of the pressure supply 600 may be deactivated in order to prevent the reservoir pressure pV from increasing again. The compressor 602 may also be deactivated indirectly, in particular by virtue of the feed line 468 being shut off.

Finally, the profile of a service brake failsafe brake pressure pN is used to show the optional possibility of a service brake failsafe braking operation BAB that is initiated by virtue of the spring brake pressurization pressure pFS being provided in the form of the service brake failsafe brake pressure pN. With the onset of ventilation of the at least one spring brake cylinder 422 starting at the first time T1, the service brake failsafe brake pressure pN builds up at the failsafe brake port 22, leading to a service brake failsafe braking operation BAB when a failsafe brake pressure threshold value pNS is reached, in this case at a third time T3.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS (PART OF THE DESCRIPTION)

1, 1′ Fail-safety valve unit
3 Ventilation port
20 Main port
22 Failsafe brake port
30 Valve main line
34 Pressure-limiting valve
40 First failsafe brake valve
40.1 First valve port of the first failsafe brake valve
40.2 Second valve port of the first failsafe brake valve
40.3 Ventilation port of the first failsafe brake valve
40.4 Solenoid part of the first failsafe brake valve
40A First position of the first failsafe brake valve
40A Second position of the first failsafe brake valve
41 Restoring spring of the first failsafe brake valve
50 Selector valve
50.1 First selector valve port
50.2 Second selector valve port
50.3 Third selector valve port
52 Shuttle valve
56 Further selector valve
60 Second failsafe brake valve, further failsafe brake valve
60.1 First valve port of the second failsafe brake valve
60.2 Second valve port of the second failsafe brake valve
60.3 Ventilation port of the second failsafe brake valve
60A First position of the second failsafe brake valve, further first position
60B Second position of the second failsafe brake valve, further second position
61 Restoring spring of the second failsafe brake valve
62 2/2 directional valve
64 2/2 directional solenoid valve
66 3/2 directional valve
68 3/2 directional solenoid valve
70 Bistable valve unit
72 Bistable valve
72.1 First bistable valve port
72.2 Second bistable valve port
72A First position of the bistable valve
72B Second position of the bistable valve
80 Failsafe relay valve
80.1 First failsafe control port
80.2 Second failsafe reservoir port
80.3 Third failsafe working port
80.4 Failsafe ventilation port
82 Axle modulator pressure sensor
84 Pressure sensor
200 Vehicle
202 Utility vehicle
204 Electropneumatic brake system
210 Front axle
212 Front wheel
220 Rear axle
222 Rear wheel
410 Electronic control unit, first electronic control unit
412 First control line
414 First supply line
416 First energy supply
418 External control unit
420 Second electronic control unit, further electronic control unit
422 Second control line
424 Second supply line
426 Second energy supply
430 Separate actuation branch
431 Axle modulator
432 Front-axle shuttle valve
433 Front-axle shuttle valve
434 Front-axle modulator
434.1 Control port of the front-axle modulator
436 Brake signal transmitter
438 Rear-axle modulator
440 Service brake cylinder
442 Spring brake cylinder
444 Service brake chamber
446 Parking brake chamber
448 Reservoir line
450 Yet further pressure reservoir
452 Further pressure reservoir
454 Pressure reservoir
458 Outlet valve
459 Further outlet valve
460 Vehicle bus line
461 Further vehicle bus line
462 Vehicle bus
463 ABS valve
464 Unit for autonomous driving
468 Feed line
470 Control connection
480 Parking brake module
482 Parking brake operator control element
484 Brake signal transmitter control line
486 Front-axle modulator control line
488 Rear-axle modulator control line
489 Pressure control device
490 Trailer control module
492 Front-axle modulator control line
494 Rear-axle modulator control line
496 Parking brake line
510 Service brake system
512 Front-axle circuit of the service brake system
514 Rear-axle circuit of the service brake system
516 Redundancy circuit
520 Parking brake system
522 Rear-axle circuit of the parking brake system
580 Pilot-control circuit of the service brake system
581 Axle modulator pilot-control circuit
584 Main circuit of the service brake system
585 Axle modulator main circuit
600 Pressure supply
602 Compressor
702 Relay valve
702.1 Valve control port of the relay valve
702.2 Reservoir port of the relay valve
702.3 Working port of the relay valve
704 Control line
706 Working line
710 Throttle
712 Dissipation bore
714 Electrical actuation branch
716 Pneumatic actuation branch
718 Redundancy port
720 Pilot-control pressurization valve
722 Pilot-control ventilation valve
730 Backup valve
740 Ventilation path
AB Braking demand
AD Diagnostic procedure
BA Failsafe braking operation
BAB Service brake failsafe braking operation
BAF Spring brake failsafe braking operation
BB Service braking operation
FA Exceptional fault
FBE Service brake ventilation function
FD Double fault
FF Fault event
FFS Parking braking function
FN Failsafe braking function
FS Electrical failure
FT Diagnostic event
pFS Spring brake pressurization pressure
pFS′ Pressure derived from the spring brake pressurization pressure
pFSE Engagement pressurization pressure
pFSS Target pressurization pressure
pN Service brake failsafe brake pressure
pNS Failsafe brake pressure threshold value
pSB Service brake pressure
pSV Service brake pilot-control pressure
pV Reservoir pressure
S1 Control signal, first control signal
S2 Further control signal, second control signal
S3 Yet further control signal, third control signal
SR Flow direction
TZI Tolerance time interval

1. A method for operating an electropneumatic brake system for a vehicle, wherein the brake system includes a service brake system and a parking brake system, the parking brake system includes at least one spring brake cylinder, the method comprising:
providing a control signal for maintaining a spring brake pressurization pressure, which pressurizes the at least one spring brake cylinder, via a control unit; and,
suspending the provision of the control signal in at least one of a fault event, an electrical failure event, and a diagnostic event of the control unit and thus automatically ending the maintenance of the spring brake pressurization pressure in order to ventilate the at least one spring brake cylinder and thus initiating a spring brake failsafe braking operation of the vehicle via the parking brake system, wherein the ventilation of the spring brake pressurization pressure is performed by a service brake ventilation function of the service brake system.

2. The method of claim 1, wherein the spring brake pressurization pressure additionally acts, during the ventilation by the service brake ventilation function, as a service brake failsafe brake pressure for initiating a service brake failsafe braking operation.

3. The method of claim 2, wherein the service brake failsafe brake pressure is provided via a failsafe brake port to at least one of a service brake cylinder, a service brake chamber, an axle modulator, and a further pneumatic brake component.

4. The method of claim 3, wherein after the provision of the service brake failsafe brake pressure, the service brake failsafe brake pressure is confined in at least one of the service brake cylinder, the service brake chamber, the axle modulator, and the further pneumatic brake component.

5. The method of claim 1, wherein the service brake ventilation function includes the opening of an outlet valve of the service brake system.

6. The method as claimed in claim 5, wherein the outlet valve is arranged in a pilot-control circuit, which carries a service brake pilot-control pressure, of the service brake system.

7. The method of claim 6, wherein said outlet valve is a pilot-control ventilation valve of an axle modulator.

8. The method of claim 1, wherein the service brake ventilation function includes the opening of a further outlet valve.

9. The method of claim 8, wherein the further outlet valve is arranged in a main circuit, which carries a service brake pressure, of the service brake system.

10. The method of claim 9, wherein the further outlet valve is a main valve of an axle modulator or an ABS valve.

11. The method of claim 1, wherein, during the ventilation of the spring brake pressurization pressure, a pressure supply that provides a supply to the parking brake system is suspended.

12. The method of claim 1, wherein, during the ventilation of the spring brake pressurization pressure, a pressure supply that provides a supply to the parking brake system is suspended by at least one of: a compressor being deactivated and a feed line being shut off.

13. The method of claim 8, wherein the pressure supply is suspended by virtue of a reservoir pressure being lowered.

14. The method of claim 8, wherein:
the pressure supply is suspended by virtue of a reservoir pressure being lowered by virtue of the pressure reservoir being emptied; and,
to empty the pressure reservoir, at least one of the outlet valve and the further outlet valve is opened.

15. The method of claim 13, wherein the further outlet valve is arranged in a brake circuit of the service brake system other than a brake circuit of the service brake system which at least one of initiates the service brake failsafe braking operation and maintains the spring brake failsafe braking operation.

16. A fail-safety valve unit for a failsafe braking function of an electropneumatic brake system for a vehicle, wherein the electropneumatic brake system includes a service brake system and a parking brake system having at least one spring brake cylinder, the fail-safety valve unit comprising:
a valve main line, which pneumatically connects a main port and a failsafe brake port;
at least one failsafe brake valve configured as a monostable valve and arranged in said valve main line;
said failsafe brake port being connectable or connected to a main circuit of the service brake system, wherein the main circuit carries a service brake pressure;
said main port being pneumatically connectable or connected to the at least one spring brake cylinder; and,
said at least one failsafe brake valve, when not actuated, being open in a first position such that ventilation of a spring brake pressurization pressure prevailing at the at least one spring brake cylinder is performed by a service brake ventilation function of the service brake system via said failsafe brake port in order to initiate a spring brake failsafe braking operation of the vehicle via the parking brake system.

17. The fail-safety valve unit of claim 16, wherein:
said at least one failsafe brake valve is actuatable by at least one control unit such that, in at least one of a fault event, an electrical failure event, and a diagnostic event of the at least one control unit, a failsafe braking operation of the vehicle is initiated by the brake system by way of at least one of the ventilation of the spring brake pressurization pressure prevailing at the at least one spring brake cylinder and the provision of a service brake failsafe brake pressure at said failsafe brake port.

18. The fail-safety valve unit of claim 16, wherein:
the fail-safety valve unit has a first failsafe brake valve configured as a monostable valve and a second failsafe brake valve configured as a monostable valve;
said first failsafe brake valve and said second failsafe brake valve are connected pneumatically in series in said valve main line; and,
said first failsafe brake valve is configured to be controlled by a first control unit and said second failsafe brake valve is configured to be controlled by a second control unit.

19. An electropneumatic brake system for a vehicle comprising a service brake system, a parking brake system and a control unit configured to carry out the method of claim 1.

20. The electropneumatic brake system of claim 19 further comprising:
a fail-safety valve unit for a failsafe braking function of an electropneumatic brake system for the vehicle;
said fail-safety valve unit having a valve main line, and at least one failsafe brake valve;
wherein said valve main line pneumatically connects a main port and a failsafe brake port;
said at least one failsafe brake valve being configured as a monostable valve and arranged in said valve main line;
said failsafe brake port being connectable or connected to a main circuit of the service brake system, wherein the main circuit carries a service brake pressure;
said main port being pneumatically connectable or connected to the at least one spring brake cylinder;
said at least one failsafe brake valve, when not actuated, being open in a first position such that ventilation of a spring brake pressurization pressure prevailing at the at least one spring brake cylinder is performed by a service brake ventilation function of the service brake system via said failsafe brake port in order to initiate a spring brake failsafe braking operation of the vehicle via the parking brake system; and,
said fail-safety valve unit being arranged in a separate actuation branch.

21. The electropneumatic brake system of claim 19, wherein said brake system has a first control unit and a second control unit which are supplied with energy independently of one another and/or which can at least partially replace one another in terms of their function.

22. The electropneumatic brake system of claim 19, wherein a service brake air quantity that can be accommodated or ventilated by the service brake ventilation function is greater than or equal to a spring brake pressure air quantity that can be accommodated by the at least one spring brake cylinder, of the parking brake system, such that the ventilation of the spring brake pressurization pressure by the service brake ventilation function results in complete ventilation of the at least one spring brake cylinder.

23. The electropneumatic brake system of claim 19, wherein a service brake air quantity that can be accommodated or ventilated by the service brake ventilation function is greater than or equal to a spring brake pressure air quantity that can be accommodated by all spring brake cylinders of the parking brake system, such that the ventilation of the spring brake pressurization pressure by the service brake ventilation function results in complete ventilation of the at least one spring brake cylinder.

24. The electropneumatic brake system of claim 19, wherein:
the electropneumatic brake system is configured to, during the ventilation of the spring brake pressurization pressure by a service brake ventilation function, suspend a pressure supply that provides a supply to the parking brake system.

25. The electropneumatic brake system of claim 24, wherein said suspension is implemented by virtue of at least one of a compressor being deactivated, a feed line being shut off, and the reservoir pressure being lowered.

26. The electropneumatic brake system of claim 19, wherein said control unit or a vehicle bus or a further electronic controller is configured to, during the ventilation of the spring brake pressurization pressure by a service brake ventilation function, suspend a pressure supply that provides a supply to the parking brake system.

27. A vehicle configured to carry out the method of claim 1.

28. A vehicle comprising the fail-safety valve unit of claim 16.

29. A vehicle comprising the electropneumatic brake system of claim 19.
